(19) United States
(12) Patent Application Publication
(10) Pub. No.: US 2002/0094794 A1
(43) Pub. Date: Jul. 18, 2002

(54) Method and apparatus for conversion of radio frequency (RF) and baseband signals

(76) Inventors: Tajinder Manku, Kitchener (CA); Chris Snyder, Lunenburg County (CA); Javad Khajehpour, Waterloo (CA)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/034,730

(22) Filed: Dec. 28, 2001

Related U.S. Application Data
(60) Provisional application No. 60/259,382, filed on Dec. 29, 2000.

(51) Int. Cl. H04B 1/18

(52) U.S. Cl. 455/189.1; 455/191.1

(57) ABSTRACT

A signal convertor for modulating or demodulating an input signal x(t), comprising: a synthesizer for generating wideband mixing signals φ₁ and φ₂, which vary irregularly over time, where φ₁*φ₂ has significant power at the frequency of a local oscillator signal being emulated; a first mixer coupled to said synthesizer for mixing said input signal x(t) with said mixing signal φ₁ to generate an output signal x(t) φ₁; and a second mixer coupled to said synthesizer and to the output of said first mixer for mixing said signal x(t) φ₁ with said mixing signal φ₂ to generate an output signal x(t) φ₁ φ₂.

### CROSS-REFERENCE TO RELATED APPLICATIONS

This application claims the benefit under 35 U.S.C. §119(e) of co-pending and commonly assigned U.S. Provisional Patent Application Serial No. 60/259,382, filed on Dec. 29, 2000, by Chris Synder et al., entitled “Translation Of An RF Signal Directly To Baseband Using Spurious Shaping And Noise Shaping.” and attorney's docket number 119.9USP1, which application is incorporated by reference herein.

### FIELD OF THE INVENTION

The present invention relates generally to communications, and more specifically, to a fully-integrable method and apparatus for up- and down-conversion of radio frequency (RF) and baseband signals using spurious shaping and noise shaping.

### BACKGROUND OF THE INVENTION

Many communication systems modulate electromagnetic signals from baseband to higher frequencies for transmission, and subsequently demodulate those high frequencies back to their original frequency band when they reach the receiver. The original (or baseband) signal, may be, for example: data, voice or video. These baseband signals may be produced by transducers such as microphones or video cameras, be computer generated, or transferred from an electronic storage device. In general, the high transmission frequencies provide longer range and higher capacity channels than baseband signals, and because high frequency RF signals can propagate through the air, they can be used for wireless channels as well as hard wired or fibre channels.

All of these signals are generally referred to as radio frequency (RF) signals, which are electromagnetic signals, that is, waveforms with electrical and magnetic properties within the electromagnetic spectrum normally associated with radio wave propagation. The electromagnetic spectrum was traditionally divided into 26 alphabetically designated bands, however, the International Telecommunication Union (ITU) formally recognizes 12 bands, from 30 Hz to 3000 GHz. New bands, from 3 THz to 3000 THz, are under active consideration for recognition.

Wired communication systems which employ such modulation and demodulation techniques include computer communication systems such as local area networks (LANs), point to point signalling, and wide area networks (WANs) such as the Internet. These networks generally communication data signals over electrical or optical fibre channels. Wireless communication systems which may employ modulation and demodulation include those for public broadcasting such as AM and FM radio, and UHF and VHF television. Private communication systems may include cellular telephone networks, personal paging devices, HF radio systems used by taxi services, microwave backbone networks, interconnected appliances under the Bluetooth standard, and satellite communications. Other wired and wireless systems which use RF modulation and demodulation would be known to those skilled in the art.

One of the current problems in the art, is to develop physically small and inexpensive modulation and demodulation techniques and devices that have good performance characteristics. For cellular telephones, for example, it is desirable to have transmitters and receivers (which may be referred to in combination as a transceiver) which can be fully integrated onto integrated circuits (ICs).

Several attempts have been made at completely integrating communication receiver designs, but have met with limited degrees of success. Most RF receivers use the “super-heterodyne” topology, which provides good performance, but does not meet the desired level of integration for modern wireless systems. The super-heterodyne topology typically requires at least two high quality filters that cannot be economically integrated within any modem IC technology. Other RF receiver topologies exist, such as image rejection architectures, which can be completely integrated on a chip but lack in overall performance.

The discussion of prior conversion techniques will be limited to demodulation (down-conversion) techniques in the interests of simplicity. The limitations of up-conversion techniques are generally similar, and regardless, are known to those skilled in the art.

Existing down-conversion techniques and their associated problems and limitations include the following:

1. Super-heterodyne;

The super-heterodyne receiver uses a two-step frequency translation method to convert an RF signal to a baseband signal. FIG. 1 presents a block diagram of a typical super-heterodyne receiver 10. The mixers labelled M1 12, MI 14, and MQ 16 are used to translate the RF signal a baseband or to some intermediate frequency (IF). The balance of the components amplify the signal being processed and filter noise from it.

More specifically, the RF band pass filter (BPF1) 18 first filters the incoming signal and corruptive noise from the antenna 20, attenuating out of band signals and passing the desired signal (note that this band pass filter 18 may also be a duplexer). A low noise amplifier 22 then amplifies the filtered antenna signal, increasing the strength of the RF signal and reducing the noise figure of the receiver 10. The signal is next filtered by another band pass filter (BPF2) 24 usually identified as an image rejection filter. The signal then enters mixer M1 12 which multiplies the signal from the image rejectior filter 24 with a periodic signal generated by the local oscillator (LO1) 26. The mixer M1 12 receives the signal from the image rejection filter 24 and translates it to a lower frequency, known as the first intermediate frequency (IF1).

Generally, a mixer is a circuit or device that accepts as its input two different frequencies and presets at its output:

(a) a signal equal in frequency to the sum of the frequencies of the input signals;

(b) a signal equal in frequency to the difference between the frequencies of the input signals; and

(c) the original input frequencies.

Note that the frequency conversion process causes a second band of frequencies to be superimposed upon the desired signal at the IF frequency. These “image frequencies” are also passed by the band pass filter 24 and corrupt the desired signal. Note also that the typical embodiment of a mixer is a digital switch, which may generate significantly more tones than those described in (a) through (c).

The IF signal is next filtered by a band pass filter (BPF3) 28 typically called the channel filter, which is centered around the IF frequency, thus filtering out mixer signals (a) and (c) above.

The signal is then amplified by an amplifier (IFA) 30, and is split into its in-phase (I) and quadratic (Q) components, using mixers MI 14 and MQ 16, and orthogonal mixing signals generated by local oscillator (LO2) 32 and 90 degree phase shifter 34. LO2 32 generates a regular, periodic signal which is typically tuned to the IF frequency, so that the signals coming from the outputs of MI 14 and MQ 16 are now at baseband, that is, the frequency at which they were originally generated. The two signals are next filtered using low pass filters LPFI 36 and LPFQ 38 to remove the unwanted products of the mixing process, producing baseband I and Q signals. The signals may then be amplified by gain-controlled amplifiers AGCI 40 and AGCQ 42, and digitized via anaog to digital converters ADI 44 and ADQ 46 if required by the receiver.

The main problems with the super-heterodyne design are:

it requires expensive off-chip components, particularly band pass filters 18, 24, 28, and low pass filters 36, 38 to remove unwanted signal components;

the off-chip components require design trade-offs that increase power consumption and reduce system gain;

image rejection is limited by the off-chip components, not by the target integration technology;

isolation from digital noise can be a problem; and

it is not fully integratable.

2. Direct Conversion:

Direct conversion architectures demoduate RF signals to baseband in a single step, by mixing the RF signa with a local oscillator signal at the carrier frequency of the RF signal. There is therefore no image frequency, and no image components to corrupt the signal. Direct conversion receivers offer a high level of integratability, but also have several important problems. Hence, direct conversion receivers have thus far proved useful only for signalling formats that do not place appreciable signal energy near DC after conversion to baseband.

A typical direct conversion receiver is shown in FIG. 2. The RF band pass filter (BPF1) 18 first filters the signal coming from the antenna 20 (this band pass filter 18 may also be a duplexer). A low noise amplifier 22 is then used to amplify the filtered antenna signal, increasing the strength of the RF signal and reducing the noise figure of the receiver 10.

The signal is then split into its quadrature components and demodulated in a single stage using mixers MI 14 and MQ 16, and orthogonal signals generated by local oscillator (LO2) 32 and 90 degree phase shifter 34. LO2 32 generates a regular, periodic signal which is lined to the incoming wanted frequency rather than an IF frequency as in the case of the super-heterodyne receiver. The signals coming from the outputs of MI 14 and MQ 16 are now at baseband, that is, the frequency at which they were originally generated. The two signals are next filtered using low pass filters LPFI 36 and LPFQ 38, are amplified by gain-controlled amplifiers AGCI 40 and AGCQ 42, and are digitized via analog to digital converters ADI 44 and ADQ 46.

Direct conversion RF receivers have several advantages over super-heterodyne systems in term of cost, power, and level of integration, however, there are also several serious problems with direct conversion. These problems include:

noise near baseband (that is, 1/f noise) which corrupts the desired signal;

local oscillator (LO) leakage in the RF path that creates DC offsets. As the LO frequency is the same as the incoming signal being demodulated, any leakage of the LO signal onto the antenna side of the mixer will pass through to the output side as well;

local oscillator leakage into the RF path that causes desensitization. Desensitation is the reduction of desired signal gain as a result of receiver reaction to an undesired signal. The gan reduction is generally due to overload of some portion of the receiver, such as the AGC circuitry, resulting in suppression of the desired signal because the receiver will no longer respond linearly to incremental changes in input voltage;

noise inherent to mixed-signal integrated circuits corrupts the desired signal;

large on-chip capacitors are required to remove unwanted noise and signal energy near DC, which makes integrability expense. These capacitors are typically placed between the mixer and the low pass filters; and

errors are generated in the quadrature signals due to inaccuracies in the 90 degree phase shifter.

3. Image Rejection Architectures:

Several image rejection architectures exist, but are not widely used. The two most well known being the Hartley Image Rejection Architecture and the Weaver Image Rejection Architecture. There are other designs, which are generally based on these two architectures, and other methods which employ poly-phase filters to cancel image components. Generally, either accurate signal phase shifts or accurate generation of quadrature local oscilators are employed in these architectures to cancel the image frequencies. The amount of image cancellation is directly dependent upon the degree of accuracy in producing the phase shift or in producing the quadrature local oscillator signals.

Although the integratability of these architectures is high, their performance is relatively poor due to the required accuracy of the phase shifts and quadrature oscillators. This architecture has been used for dual mode receivers on a single chip.

4. Near Zero-IF Conversion:

This receiver architecture is similar to the direct conversion architecture, in that the RF input signal band is translated close to baseband in a single step using a regular, periodic oscillator signal. However, the desired signal is not brought exactly to baseband and therefore DC offsets and 1/f noise do not contaminate the output signal. Image frequencies are again a problem though, as in the case of the super-heterodyne structure.

Additional problems encountered with near zero-IF architectures include:

the need for very accurate quadrature local oscillators;

the need for several balanced signal paths for purposes of image cancellation;

noise inherent to mixed-signal integrated circuits which corrupts the desired output signal; and

isolation from digital noise can be a problem.

5. Sub-sampling Down-conversion:

This method of signal down-conversion utilizes subsampling of the input signal to effect the frequency translation, that is, the input signal is sampled at a lower rate than the signal frequency. This may be done, for example, by use of a sample and hold circuit.

Although the level of integration possible with this technique is the highest among those discussed thus far, the subsampling down-conversion method suffers from two major drawbacks:

subsampling of the RF signal causes aliasing of unwanted noise power to DC. Sampling by a factor of m increases the down-converted noise power of the sampling circuit by a factor of 2m; and

subsampling also increases the effect of noise in the sampling clock. In fact, the clock phase noise power is increased by m² for sampling by a factor of m.

There is therefore a need for a method and apparatus for modulating and demodulating RF and baseband signals which allows the desired integrability along with good performance.

### SUMMARY OF THE INVENTION

It is therefore an object of the invention to provide a novel method and system of modulation and demodulation which obviates or mitigates at least one of the disadvantages of the prior art.

One aspect of the invention is broadly defined as a signal convertor for modulating or demodulating an input signal x(t), comprising: a synthesizer for generating wideband mixing signals φ₁ and φ₂, which vary irregularly over time, where φ₁*φ₂ has significant power at the frequency of a local oscillator signal being emulated; a first mixer coupled to the synthesizer for mixing the input signal x(t) with the mixing signal φ₁ to generate an output signal x(t) φ₁; and a second mixer coupled to the synthesizer and to the output of the first mixer for mixing the signal x(t) φ₁ with the mixing signal φ₂ to generate an output signal x(t) φ₁ φ₂.

Another aspect of the invention is defined as a method of converting the frequency of a signal x(t), comprising the steps of: generating wideband mixing signals φ₁ and φ₂, which vary irregularly over time, where φ₁*φ₂ has significant power at the frequency of a local oscillator signal being emulated; mixing the input signal x(t) with the mixing signal φ₁ to generate an output signal x(t) φ₁; and mixing the signal x(t) φ₁ with the mixing signal φ₂ to generate an output signal x(t) φ₁ φ₂.

A further aspect of the invention is defined as a synthesizer for generating signals to be input to successive mixers for modulating or demodulating an input signal x(t), the synthesizer comprising: a first signal generator for producing a first wideband mixing signal φ₁ which varies irregularly over time; and a second signal generator for producing a second wideband signal φ₂; which varies irregularly over time; where φ₁*φ₂ has significant power at the frequency of a local oscillator signal being emulated.

The invention could also be embodied within a single integrated circuit, on a computer readable memory medium, storing computer software code in a hardware development language for fabrication of an integrated circuit, or as a computer data signal embodied in a output wave, where the computer data signal comprises computer software code in a hardware development language for fabrication of an integrated circuit.

### BRIEF DESCRIPTION OF THE DRAWINGS

These and other features of the invention will become more apparent from the following description in which reference is made to the appended drawings in which:

FIG. 1 presents a block diagram of a super-heterodyne system as known in the art;

FIG. 2 presents a block diagram of a direct conversion or homodyne system as known in the art;

FIG. 3 presents a block diagram of a mixer and synthesizer arrangement in a broad embodiment of the invention;

FIG. 4 presents exemplary input and output signals of the invention plotted in frequency domain;

FIG. 5 presents a block diagram of a first-order delta-sigma modulator in an embodiment of the invention;

FIGS. 6A and 6B present the output of an exemplary first-order delta-sigma modulator in the frequency domain and in the time domain respectively;

FIG. 7 presents a frequency domain representation of outputs of exemplary first-, second- and third-order delta-sigma modulators;

FIG. 8 presents a block diagram of a mixer and synthesizer arrangement for converting both in-phase and quadrature components of an input signal, in an embodiment of the invention;

FIG. 9 presents a block diagram of a circuit for generating mixing signals φ_{1I} and φ_{1Q} from signals φ₂, LOI and LOQ, in an embodiment of the invention;

FIG. 10 presents a block diagram of a circuit for generating φ₂, in an embodiment of the invention;

FIG. 11 presents a block diagram of a complete receiver block in an embodiment of the invention;

FIG. 12 presents a block diagram of an embodiment of the invention employing an intermediate filter in the signal path; and

FIG. 13 presents a block diagram of an embodiment of the invention employing N mixers and N time-domain signals.

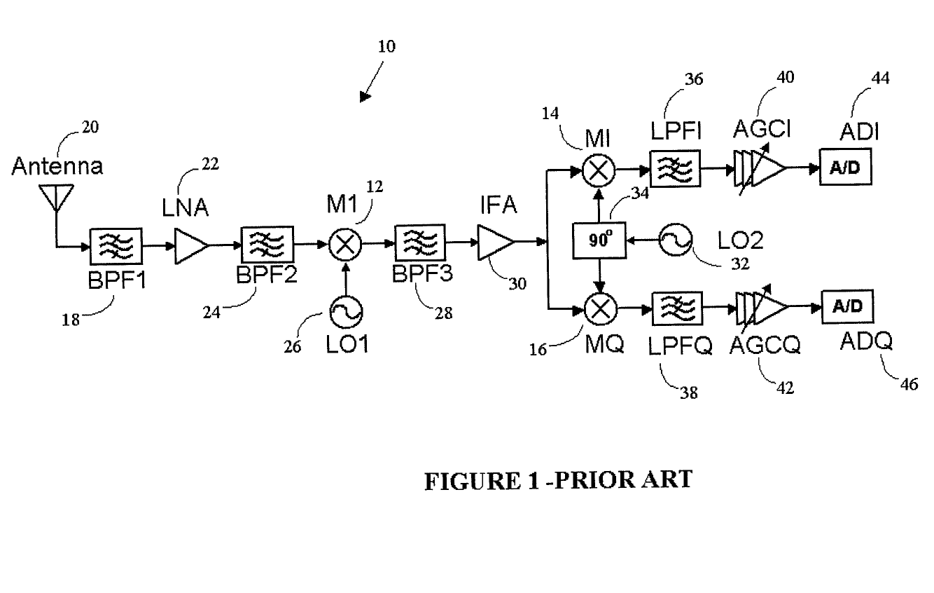

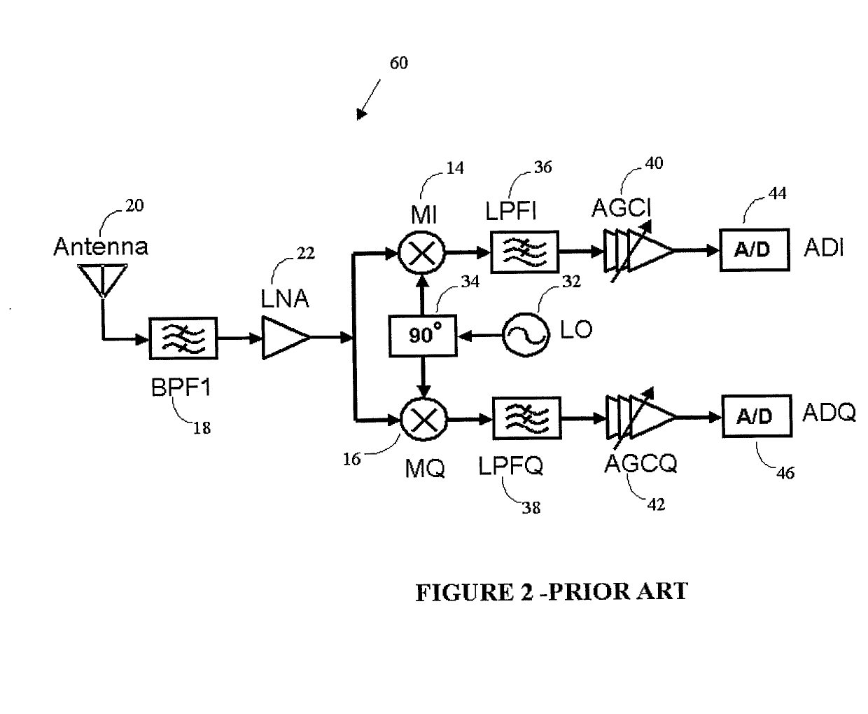

### DETAILED DESCRIPTION OF THE INVENTION

The present invention relates to the frequency translation of RF and baseband signals in highly integrated receivers and transmitters. It is particularly concerned with the generation of signals used in the translation process which have properties that solve the image-rejection problems associated with heterodyne receivers and transmitters, and the LO-leakage and 1/f noise problems associated with direct conversion receivers and transmitters.

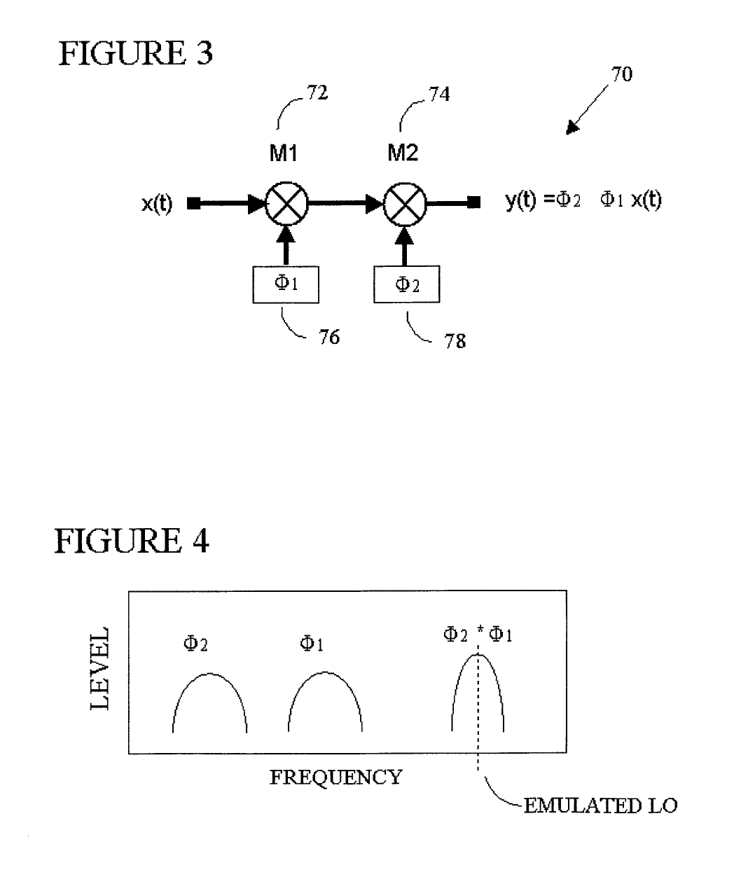

A circuit which addresses the objects outlined above, is presented as a block diagram in FIG. 3. This figure presents a modulator or demodulator topography 70 in which an input signal x(t) is mixed with two synthesized wideband signals labelled φ₁ and φ₂) which are irregular and vary in the time domain, to effect the desired modulation or demodulation. The two mixers M1 72 and M2 74 are standard mixers known in the art, having the typical properties of an associated noise figure, linearity response, and conversion gain. The selection and design of these mixers would follow the standards known in the art, and could be, for example, double balanced mixers. Though this figure implies various elements are implemented in analogue form, they can be implemented in digital form.

The two synthesizers 76 and 78 generate two time-varying, wideband functions φ₁ and φ₂ that together provide a virtual local oscillator (VLO) signal. These two functions have the property that their product emulates a local oscillator (LO) signal (i.e. their product has significant power at the modulation or demodulation frequency), but neither of the two mixing signals φ₁ and φ₂ has a significant level of power at the frequency of the LO being emulated.

As noted in FIG. 3, the output of this circuit is y(t)=φ₂*φ₁*x(t). This equation is usually read in a superheterodyne context as y(t)=φ₂*[φ₁*x(t)], but of course, mixing the input signals in the following manner provides the same result: y(t)=[φ₂*φ₁]*x(t). As a result, the desired modulation or demodulation is effected, but there is no LO signal to leak into the RF path.

In fact, at no point in the operation of the circuit in FIG. 3, is an actual φ₂*φ₁=LO signal ever generated. The two mixers M1 72 and M2 74 receive separate φ₁ and φ₂ signals, and mix them with their respective input signals using different physical components. Hence, there is no LO signal which may leak into the circuit 70.

FIG. 4 presents the frequency envelopes of exemplary mixing and output signals in an implementation of the invention. Clearly, neither of the mixing signals φ₁ and φ₂ have significant power at the frequency of the desired LO signal, yet their product, φ₂*φ₁, does.

The frequency envelopes of signals φ₁ and φ₂ are “wide” in that they are considerably broader than the bandwidth of the input signal x(t). As well, these mixing signals vary over time in that their frequency at a given instant, falls within their envelope shown in FIG. 4, but otherwise is randomly or pseudo-randomly distributed.

The representations shown in FIGS. 3 and 4 are exemplary, as any two-stage or multiple stage mixing architecture may be used to implement the invention (see FIG. 13 for example). As well, the synthesizers 76, 78 for generating the time-varying mixer signals φ₁ and φ₂ may be comprised of a single device, or multiple devices.

In current receiver and transmitter technology, frequency translation of an RF signal to and from baseband is typically performed by multiplying the input signal by regular, periodic, sinusoids. If one multiplication is performed, the architecture is said to be a direct-conversion or homodyne architecture, while if more than one multiplication is performed the architecture is said to be a heterodyne or super-heterodyne architecture. Direct-conversion transceivers suffer from LO leakage and 1/f noise problems which limit their capabilities, while heterodyne transceivers require image-rejection techniques which are difficult to implement on-chip with high levels of performance.

The problems of image-rejection, LO leakage and 1/f noise in highly integrated transceivers can be overcome by using “shaped noise signals”, rather than the simple, regular, periodic sinusoids currently used in the frequency translation process. These signals have tolerable amounts of power at the RF band frequencies both in the signals themselves and in any other signals produced during their generation.

The preferred criteria for selecting the functions φ₁ and φ₂ are:

(i) for the signal x(t) to be translated to baseband, φ₁(t)*φ₂(t) must have a frequency component at the carrier frequency of x(t);

(ii) in order to minimize image problems, φ₁(t)*φ₂(t) must have less than a tolerable amount energy at frequencies other than the carrier frequency of x(t) or at least far enough away that these image frequencies can be significantly filtered on-chip prior to down-conversion;

(iii) in order to minimize LO leakage problems, the signals φ₁ and φ₂ must not have significant amounts of power in the RF output signal bandwidth. That is, the amount of power generated at the output frequency should not effect the overall system performance of the transmitter or receiver in a significant manner;

(iv) also to avoid LO leakage found in conventional direct conversion and directly modulated topologies, the signals required to generate φ₁ and φ₂ or the intermediate signals which occur, should not have a significant amount of power at the output frequency;

(v) φ₂*φ₂ should not have a significant amount of power within the bandwidth of the up-converted RF (output) signal. This ensures that if φ₂ leaks into the input port, it does not produce a signal within the RF signal at the output. It also ensures that if φ₂ leaks into node between the two mixers, it does not produce a signal within the RF signal at the output;

(vi) if x(t) is an RF signal, φ₁*φ₁*φ₂ should not have a significant amount of power within the bandwidth of the RF signal at baseband. This ensures that if φ₁ leaks into the input port, it does not produce a signal within the baseband signal at the output; and

(vii) to reduce the amount of 1/f noise at baseband, the centre frequency of φ₁ should be much higher frequency than that of φ₂.

These mixing signals φ₁ and φ₂ can, in general, be random, pseudo-random, periodic functions of time, and either analogue or digital waveforms.

As well, since the mixers in most transceivers act as solid state switches being turning on and off, it is preferable to drive the mixers using square waveforms rather than sinusoids. Square waveforms with steep leading and trailing edges will switch the state of the mixers more quickly, and at a more precise moment in time than sinusoid waveforms.

It would be clear to one skilled in the art that virtual LO signals may be generated which provide the benefits of the invention to greater or lesser degrees. While it is possible in certain circumstances to have almost no LO leakage, it may be acceptable in other circumstances to incorporate virtual LO signals which still allow a degree of LO leakage. The more thoroughly the above criteria (i)-(vii) for selection of the φ₁ and φ₂ signals are complied with, the more effective the invention will be in overcoming the problems in the art.

The topology of the invention is similar to that of two stage or multistage modulators and demodulators, but the use of wideband, irregular, time-varying mixer signal provides fundamental advantages over known transmitters and receivers. For example:

minimal 1/f noise;

minimal imaging problems;

minimal leakage of a local oscillator (LO) signal into the RF output band;

removes the necessity of having a second LO and various (often external) filters; and

has a higher level of integration as the components it does require are easily placed on an integrated circuit. For example, no large capacitors or sophisticated filters are required.

The invention provides the basis for fully integrated communications transmitters and receivers. Increasing levels of integration have been the driving impetus towards lower cost, higher volume, higher reliability and lower power consumer electronics since the inception of the integrated circuit. This invention will enable communications devices to follow the same integration route that other consumer electronic products have benefited from.

Specifically, advantages from the perspective of the manufacturer when incorporating the invention into a product include:

1. significant cost savings due to the decreased parts count of an integral device. Decreasing the parts count reduces the cost of inventory control, reduces the costs associated with warehousing components, and reduces the amount of manpower to deal higher part counts;

2. significant cost savings due to the decreased manufacturing complexity. Reducing the complexity reduces time to market, cost of equipment to manufacture the product, cost of testing and correcting defects, and reduces time delays due to errors and problems on the assembly line;

3. reduces design costs due to the simplified architecture. The simplified architecture will shorten the first-pass design time and total design cycle time as a simplified design will reduce the number of design iterations required;

4. significant space savings and increased manufacturability due to the high integrability and resulting reduction in product form factor (physical size). This implies huge savings throughout the manufacturing process as smaller device footprints enable manufacturing of products with less material such as printed circuit substrate, smaller product casing, and smaller final product packaging;

5. simplification and integrability of the invention will yield products with higher reliability, greater yield, less complexity, higher life span and greater robustness; and

6. due to the aforementioned cost savings, the invention will enable the creation of products that would otherwise be economically unfeasible. Hence, the invention provides the manufacturer with a significant competitive advantage.

From the perspective of the consumer, the marketable advantages of the invention include:

lower cost products, due to the lower cost of manufacturing;

higher reliability as higher integration levels and lower parts counts imply products will be less prone to damage from shock, vibration and mechanical stress;

higher integration levels and lower parts counts imply longer product life span;

lower power requirements and therefore lower operating costs;

higher integration levels and lower parts counts imply lighter weight and physically smaller products; and

the creation of economical new products.

Preferred Embodiments of the Invention

The invention can be applied in many ways which would be clear to one skilled in the art from the teachings herein. A number of manners of creating VLO signals and applying them are described hereinafter, but it is understood that these embodiments are exemplary and not limiting.

In the preferred embodiment of the invention, it is intended that the synthesizers be embodied using delta-sigma modulators. Delta-sigma modulators have been chosen because they can be used to generate pseudo-random bit streams, but more importantly, because their frequency envelopes can be shaped as required by the application. The design of delta-sigma modulators is generally known in the art of electronics, and in particular, to those skilled in the design of digital to analogue convertors.

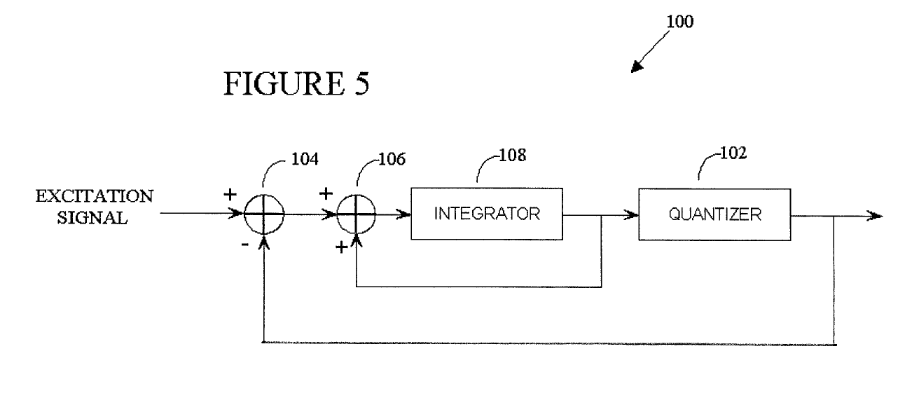

FIG. 5 presents a simple, 1-bit, first-order, delta-sigma modulator 100. As will be explained in greater detail hereinafter, higher-order modulators will generally be used, but it is easier to explain the principles of operation from this simple example.

Delta-sigma modulators are used in the art to convert analogue inputs to low-resolution digital signals at a very high sampling rate, a typical application being the encoding of audio compact disks. The invention takes advantage of the delta-sigma circuit's property that its average output will track the average input, so that proper design can be used to generate a pseudo-random bitstream that falls within a predictable frequency envelop.

Referring to FIG. 5. the output of the quantizer 102 be a digital signal which is fed back to the first summer 104. This first summer 104 provides the “delta” component of the circuit as it compares the input “excitation signal” to the output of the quantizer 102, generating an error signal. The error signals are accumulated by the second summer 106 (the “sigma” component of the circuit), the integrator 108 and the associated feedback loop. Once the magnitude of the integrator 108 output is large enough, the quantizer 102 will switch from a low state to a high state (i.e. switching its output from a binary 0 to 1), effectively causing a negative output from the first summer 104. Negative error signals will then accumulate in the accumulator loop until the output of the integrator 108 is sufficient to cause the quantizer 102 to switch from a high state back to a low state again (i.e. from a 1 to a 0).

While this seems much like a simple oscillator, proper selection of design parameters for the circuit and values for the excitation signal and clock frequency, will cause the circuit to generate a pseudo-random bit stream with desired length and profile. Higher order circuits (i.e. with additional integrators) will generate much longer bit streams before repetition will occur. In the case of the invention, the delta-sigma modulator will be designed to shape the output spectrum to suppress unwanted spurious signals within φ₁*φ₂ or φ₁*φ₂, and also to suppress the 1/f noise at baseband.

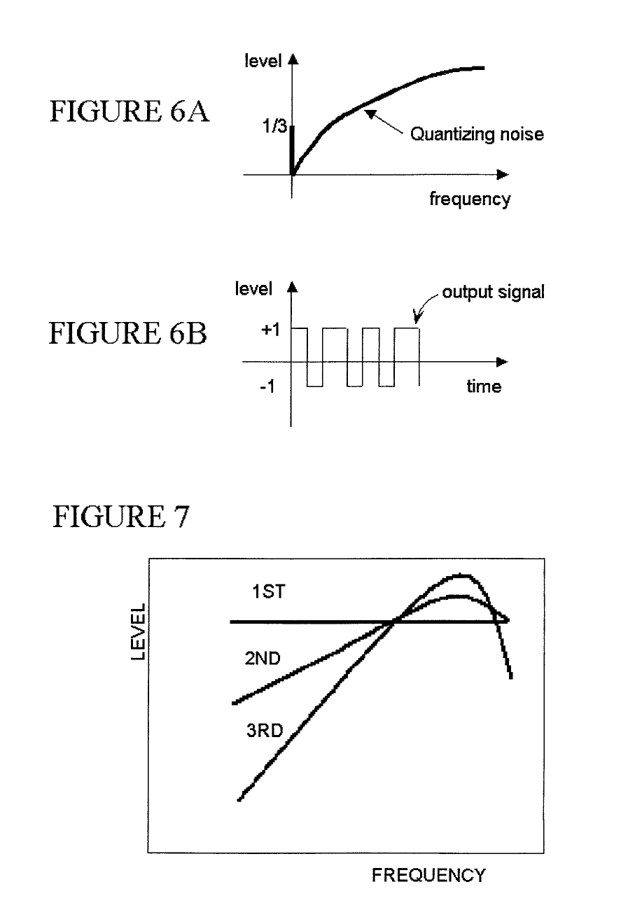

The output of an exemplary first-order delta-sigma modulator will generally appear as shown in FIGS. 6A and 6B. In this case, the excitation signal is a DC signal at ⅓ volt, and the quantizer 102 drives the output to +1 or −1. FIG. 6A presents the output of the modulator 100 in the frequency domain, where there is a DC signal at ⅓, and quantization noise at higher frequencies. In the time domain, the output signal will appear as shown in FIG. 6B, oscillating between +1 and −1 in a pseudo-random fashion. This signal will, of course, have an average value of ⅓, and have quantized noise associated with it. As noted above, the period of a first-order delta-sigma modulator is much shorter than that of higher order delta-sigma modulators.

FIG. 7 presents the quantization noise that will be produced by first-, second- and third-order delta-sigma modulators in the frequency domain. As noted above, this document does not intend to provide a complete analysis of delta-sigma modulator design, as it is well known in the arts of communication and analogue to digital conversion. It is simply the point of FIG. 7 to show that different modulator designs can be implemented to provide different frequency spectra, and that higher order modulators will push the quantization noise to higher frequencies.

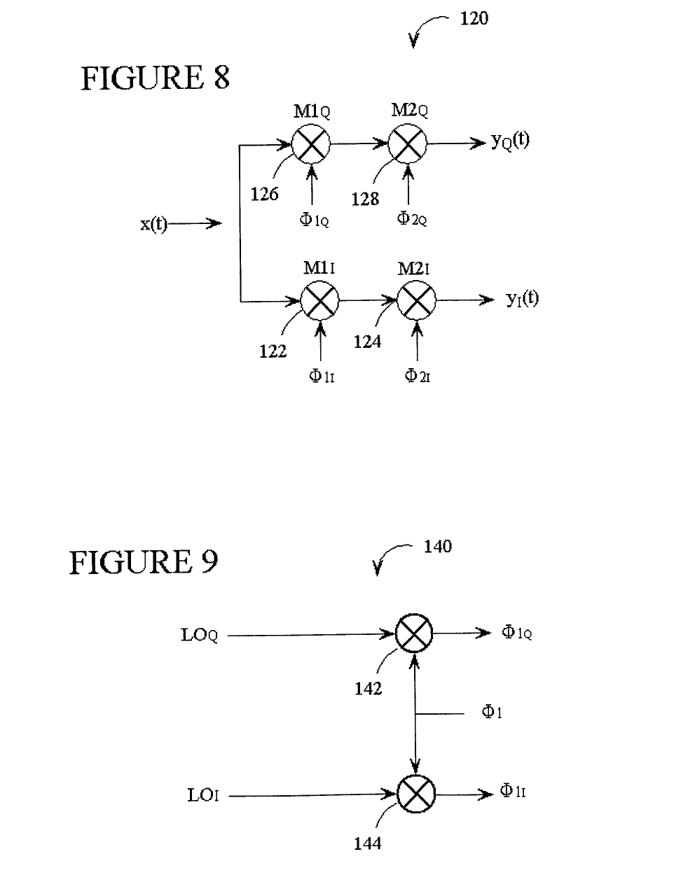

It is also important to note that in many modulation schemes, it is necessary to modulate or demodulate both in-phase (I) and quadrature (Q) components of the input signal, which requires a modulator or demodulator 120 as presented in the block diagram of FIG. 8. In this case, four modulation functions have to be generated: φ_{1I} which is 90 degrees out of phase with φ_{1Q}; and φ_{2I} which is 90 degrees out of phase with φ_{2Q}. The pairing of signals φ_{1I} and φ_{2I} must meet the function selection criteria listed above, as must the signal pairing of φ_{1Q} and φ_{2Q}. The mixers 92, 94, 96, 98 are standard mixers as known in the art.

The circuits described herein are generally presented as single channel circuits rather than as separate in-phase and quadrature channels (I and Q channels), in the interests of simplicity. It would be clear to one skilled in the art how to generate complementary I and Q channels and the necessary mixing signal pairs from the teachings herein.

As shown in FIG. 8, mixer M1I 122 receives the input signal x(t) and mixes it with φ_{1I}; subsequent to this, mixer M2I 124 mixes signal x(t) φ_{1I} with φ_{2I} to yield the in-phase component of the input signal, that is, y_{I}(t)=x(t) φ_{1I} φ_{2I}. A complementary process occurs on the quadrature side of the demodulator, where mixer M1Q 126 receives the input signal x(t) and mixes it with φ_{1Q}; after which mixer M2Q 128 mixes signal x(t) φ_{IQ} with φ_{2Q} to yield the quadrature phase component of the input signal, that is, y_{Q}(t)=x(t) φ_{1Q} φ_{2Q}.

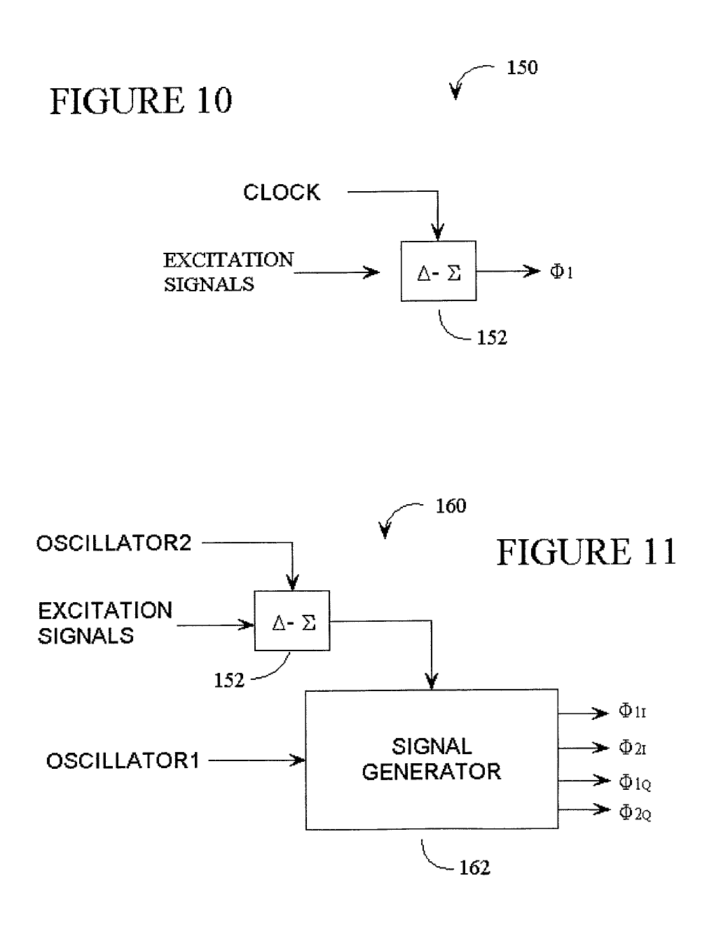

FIGS. 9 through 11 present block diagrams of circuits for generating I and Q channel VLO signals in a manner of the invention. FIGS. 9 and 10 present two building blocks that are assembled in FIG. 11 to provide the complete circuit.

In FIG. 9. two mixers 142, 144 are used to provide φ_{1Q} and φ_{2Q} mixing signals from a single wideband, pseudo-random bit stream signal, φ₁. As shown in FIG. 10. this pseudorandom bit stream signal φ₁ can be produced using a delta-sigma modulator 152 as known in the art. The clock input defines what is know as the “over-sampling rate of” the delta-sigma block 152.

The other inputs to the two mixers 142, 144 are local oscillator signals LO_{Q} and LO_{I}. These two signals can be generated in many ways as known in the act the different between the two signals simply being a 90 degree phase shift.

Since an LO-leakage problem can occur when power is generated at frequencies of the incoming signal x(t), or the intermediate frequencies such as x(t)*φ₁, it is preferable that condition (iv) stated above be followed (i.e. that LO-leakage prone signals are not produced at any time). In the case of delta-sigma modulation, it is easy to satisfy this condition because apart from the requirement that φ₁*φ₂ have power at the frequency of the local oscillator being emulated, the only other constraint on φ₁ and φ₂ is that their frequency be sufficient to sample the incoming signal. Hence, local oscillator signals LO_{Q} and LO_{I} can easily be designed to avoid the frequencies in the signal path and reduce the potential for LO leakage to cause problems.

With the building blocks of FIGS. 9 and 10, the complete convertor 160 can now be assembled per FIG. 11. The Signal Generator 162 contains two circuits as in FIG. 9, the first providing output signals to the first pair of mixers in FIG. 8. M1Q 126 and M1I 122, and the second providing mixing signals for the second pair of mixers M2Q 128 and M2I 124. The only constraint on the second system is that the ultimate output signals φ_{2Q} and φ_{2I} complement those of the first system, φ_{1Q} and φ_{1I}. By this, we mean that their products φ_{1Q}*φ_{2Q}, and φ_{1I}*φ_{2I} emulate the desired LO being emulated.

As noted above, the clock input to the delta-sigma modulator 152 (oscillator 2) dictates the over-sampling rate of the modulator 152. The delta-sigma modulator 152, of course, could be replaced with any wideband signal generator which provides a signal satisfying the above conditions.

The clock input to the signal generator block 162 is simply the time base that is used to generate the local oscillator signals LO_{Q} and LO_{I}. The signal generator block 162 can consist of digital blocks or analog blocks.

The invention allows one to fully integrate RF transmitters and receivers on a single chip without using external filters, while furthermore, RF transceivers can be used as multi-standard transceivers.

The construction of the necessary logic to generate the mixing signals of the invention would be clear to one skilled in the art from the description herein. Such signals may be generated using basic logic gates, field programmable gate arrays (FPGA), read only memories (ROMs), micro-controllers or other devices known in the art. Though the figures herein imply the use of analogue components, all embodiments can be implemented in digital form.

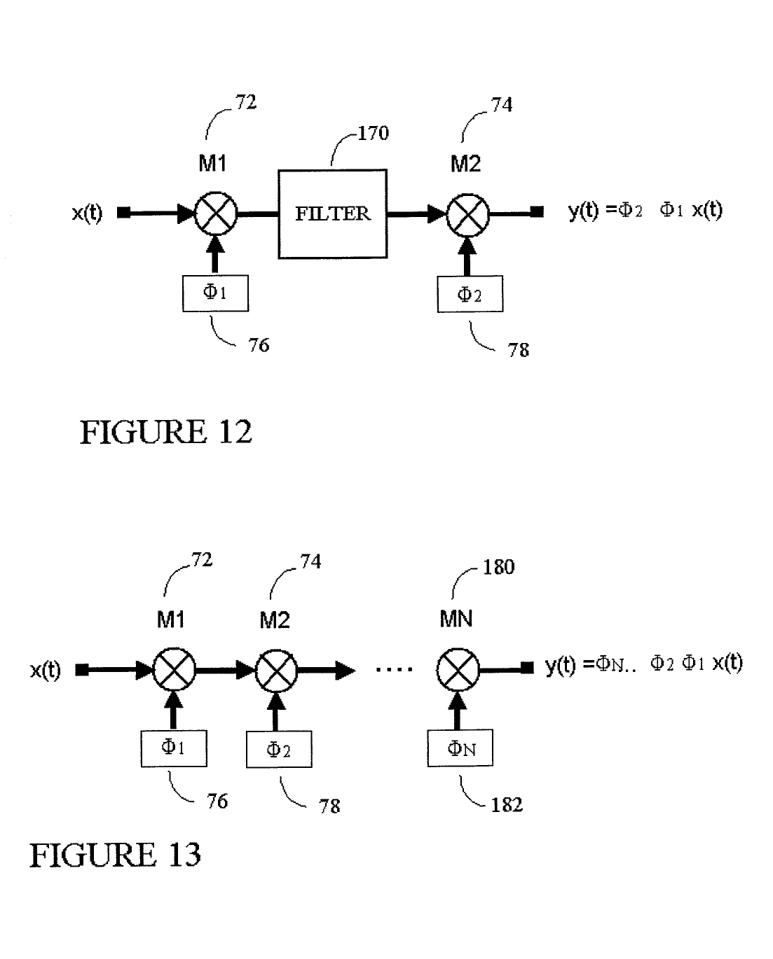

It would also be clear to one skilled in the art that many variations may be made to the designs presented herein, without departing from the spirit of the invention. One such variation to the basic structure in FIG. 12 is to add a filter 170 between the two mixers 72 and 74 to remove unwanted signals that are transferred to the output port. This filter may be a low pass, high pass, or band pass filter depending on the convertor requirements, and may be purely passive, or have active components.

In FIG. 3, two mixer signals are used to perform the down-conversion or up-conversion of x(t). It is also possible to use more than two signals to reach the same goal. The block diagram of FIG. 13 presents such a variation, where several functions φ₁, φ₂, φ₃ . . . φₙ are used to generate the virtual LO (using the associated mixers 7, 74, 180 and signal synthesizers 76, 78, 182).

Here, the product φ₁*φ₂* . . . *φₙ has a significant power level at the LO frequency being emulated, but each of the functions φ₁, φ₂, φ₃ . . . φₙ contain an insignificant power level at the LO frequency. Mixing signals φ₁, φ₂, φ₃ . . . φₙ can be generated using the techniques described hereinabove.

The electrical circuits of the invention may be described by computer software code in a simulation language, or hardware development language used to fabricate integrated circuits. This computer software code may be stored in a variety of formats on various electronic memory media including computer diskettes, CD-ROM, Random Access Memory (RAM) and Read Only Memory (ROM). As well, electronic signals representing such computer software code may also be transmitted via a communication network.

Clearly, such computer software code may also be integrated with the of other programs, implemented as a core or subroutine by external program calls, or by other techniques known in the art.

The embodiments of the invention may be implemented on various families of integrated circuit technologies using digital signal processors (DSPs), microcontrollers, microprocessors, field programmable gate arrays (FPGAs), or discrete components. Such implementations would be clear to one skilled in the art.

The invention may be applied to various communication protocols and formats including: amplitude modulation (AM), frequency modulation (FM), frequency shift keying (FSK), phase shift keying (PSK), cellular telephone systems including analogue and digital systems such as code division multiple access (CDMA), time division multiple access (TDMA) and frequency division multiple access (FDMA).

The invention may be applied to such applications as wired communication systems include computer communication systems such as local area networks (LANs), point to point signalling, and wide area networks (WANs) such as the Internet, using electrical or optical fibre cable systems. As well, wireless communication systems may include those for public broadcasting such as AM and FM radio, and UHF and VHF television; or those for private communication such as cellular telephones, personal paging devices, wireless local loops, monitoring of homes by utility companies, cordless telephones including the digital cordless European telecommunication (DECT) standard, mobile radio systems, GSM and AMPS cellular telephones, microwave backbone networks, interconnected appliances under the Bluetooth standard, and satellite communications.

While particular embodiments of the present invention have been shown and described, it is clear that changes and modifications may be made to such embodiments without departing from the true scope and spirit of the invention. The present invention relates to the translation of an RF signal directly to baseband and is particular concerned with solving the LO-leakage problem and the 1/f noise problems associated with the present art. The invention allows one to fully integrate a RF receiver on a single chip without using external filters. Furthermore the RF receiver can be used as a multi-standard receiver.

What is claimed is:

1. A signal convertor for modulating or demodulating an input signal x(t), comprising:
a synthesizer for generating wideband mixing signals φ₁ and φ₂, which vary irregularly over time, where φ₁*φ₂ has significant power at the frequency of a local oscillator signal being emulated;
a first mixer coupled to said synthesizer for mixing said input signal x(t) with said mixing signal φ₁ to generate an output signal x(t) φ₁; and
a second mixer coupled to said synthesizer and to the output of said first mixer for mixing said signal x(t) φ₁ with said mixing signal φ₂ to generate an output signal x(t) φ₁ φ₂.

2. The signal convertor of claim 1, where said synthesizer comprises:
a synthesizer for generating mixing signals φ₁ and φ₂, where φ₁ and φ₂ have different patterns.

3. The signal convertor of claim 2 wherein said synthesizer further comprises:
a synthesizer for generating mixing signals φ₁ and φ₂, where neither φ₁ nor φ₂ have significant power at the frequency of said local oscillator signal being emulated.

4. The signal convertor of claim 3 wherein said synthesizer further comprises:
a synthesizer for generating mixing signals φ₁ and φ₂, where φ₁*φ₁*φ₂ does not have a significant amount of power within the bandwidth of said input signal x(t) at baseband, thereby reducing adverse effects of local oscillator leakage.

5. The signal convertor of claim 4 wherein said synthesizer further comprises:
a synthesizer for generating mixing signals φ₁ and φ₂, where φ₂*φ₂ does not have a significant amount of power within the bandwidth of said input signal x(t) at baseband, thereby reducing adverse effects of local oscillator leakage.

6. The signal convertor of claim 1 wherein said synthesizer further comprises:
a synthesizer for randomly generating mixing signals φ₁ and φ₂.

7. The signal convertor of claim 1 wherein said synthesizer further comprises:
a synthesizer for pseudo-randomly generating mixing signals φ₁ and φ₂.

8. The signal convertor of claim 7 wherein said synthesizer further comprises:
a synthesizer which can shape the spectrum of said mixing signals φ₁ and φ₂.

9. The signal convertor of claim 8 wherein said synthesizer further comprises:
a delta-sigma block for generating said mixing signals φ₁ and φ₂.

10. The signal convertor of claim 9 wherein the control signal and oversampling rate of the delta-sigma block vary with time.

11. The signal convertor of claim 7 wherein said synthesizer further comprises:
a synthesizer for generating mixing signals φ₁ and φ₂, where said mixing signals φ₁ and φ₂ can change with time in order to reduce errors.

12. The signal convertor of claim 7, further comprising:
a filter for removing unwanted signal components from said x(t) φ₁ signal.

13. The signal convertor of claim 7, wherein said mixing signals φ₁ and φ₂ are digital waveforms.

14. The signal convertor of claim 7, wherein said mixing signals φ₁ and φ₂ are square waveforms.

15. The signal convertor of claim 7, further comprising:
a local oscillator coupled to said synthesizer for providing a signal having a frequency that is an integral multiple of the desired mixing frequency.

16. The signal convertor of claim 7, wherein said synthesizer uses a single time base to generate both mixing signals φ₁ and φ₂.

17. The signal convertor of claim 7 wherein said synthesizer further comprises:
a synthesizer for generating mixing signals φ₁ and φ₂, wherein φ₁ is at a much higher frequency than φ₂, thereby reducing the amount of 1/f noise in the output, at base band.

18. The signal convertor as claimed in claim 7, wherein said first and second time-varying signals are periodic functions of time.

19. The signal convertor as claimed in claim 7, wherein said synthesizer comprises:
a synthesizer for generating time-varying signals φ₁ and φ₂, where both φ₁ and φ₂ are operating at a much higher frequency than said local oscillator signal being emulated.

20. A signal convertor comprising two signal paths as claimed in claim 7, wherein said two sets of mixing signals are 90 degrees out of phase (φ_{1Q} and φ_{2Q} or φ_{1I} and φ_{2I}), thereby generating in-phase and quadrature components of said input signal x(t).

21. The synthesizer of claim 7 comprising:
one or more additional signal generators for producing one or more additional time-varying signals;
where the product of all of said time-varying signals has significant power at the frequency of a local oscillator signal being emulated, and none of said all of said time-varying signals has significant power at the frequency of said local oscillator signal being emulated.

22. A method of converting the frequency of a signal x(t), comprising the steps of:
generating wideband mixing signals φ₁ and φ₂, which vary irregularly over time, where φ₁*φ₂ has significant power at the frequency of a local oscillator signal being emulated;
mixing said input signal x(t) with said mixing signal φ₁ to generate an output signal x(t) φ₁; and
mixing said signal x(t) φ₁ with said mixing signal φ₂ to generate an output signal x(t) φ₁ φ₂.

23. A synthesizer for generating signals to be input to successive mixers for modulating or demodulating an input signal x(t), said synthesizer comprising:
a first signal generator for producing a first wideband mixing signal φ. which varies irregularly over time; and
a second signal generator for producing a second wideband signal φ₂ which varies irregularly over time;
where φ₁*φ₂ has significant power at the frequency of a local oscillator signal being emulated.

24. An integrated circuit comprising the device of claim 1.

25. A computer readable memory medium, storing computer software code in a hardware development language for fabrication of an integrated circuit comprising the device of claim 1.

26. A computer data signal embodied in a output wave, said computer data signal comprising computer software code in a hardware development language for fabrication of an integrated circuit comprising the device of claim 1.
